(19) United States
(12) Patent Application Publication
(10) Pub. No.: US 2003/0215117 A1
(43) Pub. Date: Nov. 20, 2003

(54) Fingerprint entering apparatus and method for manufacturing fingerprint entering apparatus

(75) Inventor: Fumio Hata, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/434,113

(22) Filed: May 9, 2003

(30) Foreign Application Priority Data
May 14, 2002 (JP) 2002-139021
Dec. 11, 2002 (JP) 2002-359457
Apr. 30, 2003 (JP) 2003-125370

(51) Int. Cl. G06K 9/00

(52) U.S. Cl. 382/124

(57) ABSTRACT

A fingerprint entering apparatus which has small number of parts and can be produced by simple manufacturing process and further is cheap is provided. When a near infrared ray and/or infrared ray is radiated from a LED toward a finger place closely on a transparent electrode provided on a rear face of a substrate, the radiated ray is scattered in the inside of a fingertip, and exits from a portion of a fingerprint. The scattered ray transmits the transparent electrode and the substrate to be photoelectrically converted by solid state imaging devices provided on a front face of the substrate, and thereby an image of the fingerprint can be obtained. The fingerprint entering apparatus is featured by the thickness of the substrate being within a range from about a half to three times as large as the pixel pitch of the solid state imaging devices.

### BACKGROUND OF THE INVENTION

1. Field of the Invention

The present invention relates to a fingerprint entering apparatus for radiating an infrared ray and/or a near infrared ray to a finger to receive scattered light from the inside of a fingertip with solid state imaging device.

2. Related Background Art

In recent years, as economic activities such as electric commerce and the like have spread widely owing to the remarkable advance of information technology, and the necessity of electronizing personal authentication has increased with the object of preventing illegal use.

As a technique for electronizing the personal authentication, a method of entering a fingerprint as an image has frequently been used conventionally. For example, a method disclosed in Japanese Patent Application Laid-Open No. 2000-11142 utilizes a total reflection prism. The method has the following disadvantages. That is, they are: the size of the apparatus for implementing the method is too large, the method cannot discriminate a forged fingerprint profiled with a resin or the like from the true one, and the like.

As a small sized highly reliable fingerprint entering apparatus improving the disadvantages, a method, disclosed in Japanese Patent No. 3150126, has been proposed. The method radiates a near infrared ray to a finger touching a point approximate to the front face of two-dimensional solid state imaging devices, and receives scattered light from the inside of the fingertip.

FIG. 11 is a typical sectional view showing the conventional fingerprint entering apparatus. A reference numeral 1 designates a semiconductor substrate. A reference numeral 1a designates solid state imaging devices formed on the front face of the semiconductor substrate 1. As the solid state imaging devices 1a, two-dimensionally arranged image sensors are ordinarily used, and the pitch of the arrangement is designated by a letter p. A reference numeral 11d designates cover glass for protecting the solid state imaging devices 1a, and the thickness of the cover glass 11d is designated by a letter t.

For entering a fingerprint into the image sensors, incident light 2a composed of a near infrared ray and/or an infrared ray is radiated from a light emitting diode (LED) 2 to a finger 3 placed on the front face of the cover glass lid closely. The light 2a is scattered in the inside of the finger 3, and exits from the portion of a fingerprint 3a and the like. The solid state imaging devices 1a perform the photoelectric conversion of the scattered light 2b to obtain an image of the fingerprint 3a.

In entering a fingerprint, the pitch p of the solid state imaging devices 1a is preferably 50 μm or less as described in Japanese Patent No. 3150126. Consequently, the thickness of the cover glass lid is also preferably 50 μm or less in order that an image of the fingerprint 3a formed by the scattered light 2b may clearly arrive at the solid state imaging devices 1a.

FIG. 12 is a typical sectional view showing another conventional fingerprint entering apparatus.

In FIG. 12, the two-dimensionally arranged solid state imaging devices 1a are formed on the front face of the semiconductor substrate 1. The cover glass 11d is fixed on the imaging devices 1a by being bonded thereon with a transparent sealing resin 77. Then, the above-mentioned components are fixed on a wiring substrate 72, and the semiconductor substrate 1 is electrically connected to wiring 73a with wires 76. Moreover, illumination LED chips 70 are also connected to the wiring 73a with wires 75, and are protected by a sealing resin 74.

The incident light 2a radiated from the LED 2 enters into the finger 3, and is scattered in the inside of the finger 3. Then, the scattered light 2b enters the cover glass lid through the fingerprint 3a. When the scattered light 2b arrives at the solid state imaging devices 1a, the photoelectric conversion of the scattered light 2b is performed by the solid state imaging devices 1a. Thereby, an electric signal of the fingerprint image can be obtained.

It is necessary to make the cover glass lid have an optical filter function for eliminating disturbance light other than fingerprint images in addition to an object for protecting the solid state imaging devices 1a from being broken electrically and mechanically by a touch of the finger 3 and the like to the solid state imaging devices 1a.

However, the thickness t of the cover glass lid is needed to be exceedingly thin for obtaining a clear fingerprint image. For satisfying the requirement, an expensive material such as a fiber-optic plate or the like must be used.

On the other hand, as a technique for making the cover glass lid unnecessary, a method for entering an fingerprint image from the rear face of a solid state imaging device chip (semiconductor substrate) has also been proposed. For example, Japanese Patent Application Laid-Open No. 2002-33469 discloses such a method.

FIG. 13 is a typical sectional view showing a further conventional fingerprint entering apparatus.

In FIG. 13, a light receiving portion 83 is formed on the front face of a silicon (Si) substrate 81. The light receiving portion 83 is covered with an interlayer insulation film 82. A reference numeral 84 indicates a peripheral metal oxide semiconductor field effect transistor (MOSFET), and a reference numeral 85 designates wiring. When the finger 3 touches the rear face of a MOS image sensor chip 80 and then, for example, a near infrared ray is radiated on the finger 3, the light from the fingerprint 3a enters the light receiving portion 83. In the conventional fingerprint entering apparatus, the finger 3 does not directly touch the front face of the chip 80 on the solid state imaging device side, and the finger 3 touches the rear face of the chip 80. Consequently, the damage and the deterioration of the chip 80 can be prevented. However, the conventional technique does not specially perceive the thinning of the Si substrate 81.

However, single crystal silicon and other semiconductor substrates constituting a semiconductor element are generally a brittle material, and consequently they are sometimes damaged when a human finger frequently touches or pushes them.

Moreover, it is difficult to handle such a thin substrate in its manufacturing process also. The probability of damaging is high especially at the time of performing electrical connection of its electrode to the outside.

### SUMMARY OF THE INVENTION

The present invention was devised for settling the problems mentioned above, and aims to provide a novel fingerprint entering apparatus and a method manufacturing the finger print entering apparatus, both capable of performing the connection and the fixation of a semiconductor substrate having an ordinary thickness (about 0.3 to 0.8 mm) to an electrode on the wiring substrate side, and capable of working the semiconductor substrate to be thin after that, and then capable of preventing the damage of the semiconductor substrate during the manufacturing process and the use of the semiconductor substrate.

The fingerprint entering apparatus of the present invention is one including solid state imaging devices receiving scattered light from an inside of a fingertip, and a semiconductor substrate having a front face, on which a plurality of the solid state imaging devices formed, and a rear face, from which the scattered light enters the solid state imaging devices, the rear face being substantially parallel to the front face of the semiconductor substrate, wherein the thickness of the semiconductor substrate is within a range from about a half to three times as large as a pixel pitch of the solid state imaging devices.

### BRIEF DESCRIPTION OF THE DRAWINGS

FIG. 1 is a typical sectional view showing a schematic configuration of a fingerprint entering apparatus of a first embodiment of the present invention;

FIG. 2 is a typical sectional view showing an enlarged light beam path portion of FIG. 1;

FIG. 3 is a graph showing light quantity ratios to thickness to pitch ratios;

FIG. 4 is a typical sectional view showing a fingerprint entering apparatus of a second embodiment of the present invention;

FIGS. 5A, 5B, 5C and 5D are typical sectional views showing a manufacturing process of a fingerprint entering apparatus of the present invention;

FIG. 6 is a typical sectional view showing a fingerprint entering apparatus of a third embodiment of the present invention;

FIG. 7 is a typical sectional view of a fingerprint entering apparatus of a fourth embodiment of the present invention;

FIG. 8 is a typical sectional view of a fingerprint entering apparatus of a fifth embodiment of the present invention;

FIGS. 9A and 9B are typical sectional views of a fingerprint entering apparatus of a sixth embodiment of the present invention;

FIG. 10 is a typical sectional view of a fingerprint entering apparatus of a seventh embodiment of the present invention;

FIG. 11 is a typical sectional view of a conventional fingerprint entering apparatus;

FIG. 12 is a typical sectional view of another conventional fingerprint entering apparatus; and

FIG. 13 is a typical sectional view of a further conventional fingerprint entering apparatus.

### DETAILED DESCRIPTION OF THE PREFERRED EMBODIMENTS

Hereinafter, the preferred embodiments of the present invention will be described by reference to the attached drawings.

(First Embodiment)

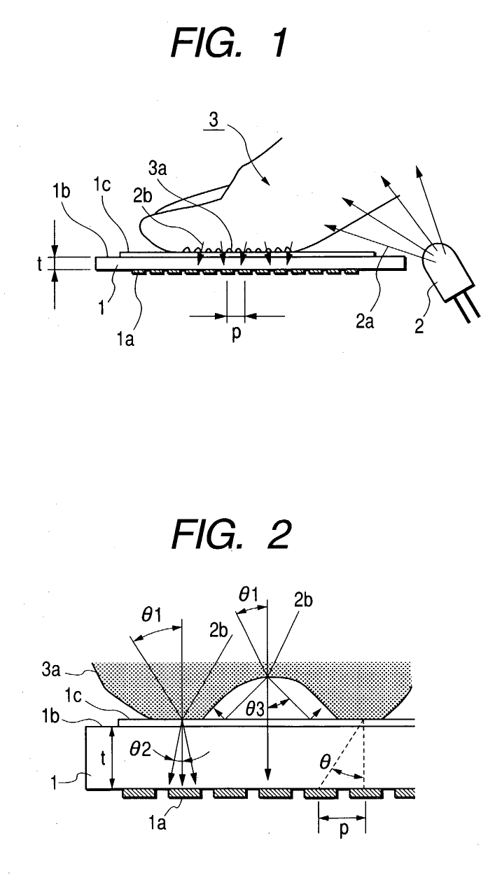

FIG. 1 is a typical sectional view showing a schematic configuration of a fingerprint entering apparatus of a first embodiment of the present invention. In the figure, a reference numeral 1 designates a semiconductor substrate, and a reference numeral 1a designates a plurality of solid state imaging devices formed on the semiconductor substrate 1. As the solid state imaging devices 1a, two-dimensionally arranged image sensors are ordinarily used. The semiconductor substrate 1 is a single crystal silicon wafer, on which the solid state imaging devices 1a such as charge coupled devices (CCD's), complementary metal oxide semiconductors (CMOS's) and the like are produced by a known semiconductor process technique. Since near infrared rays having a wavelength of about 1200 nm or more well transmit the single crystal silicon, it is also possible for the solid state imaging devices 1a to perform the photoelectric conversion of the light beams which have entered the semiconductor substrate 1 from its rear face 1b side.

A reference numeral 1c designates a transparent conductive film such as an indium tin oxide (ITO) film or the like, which is formed on the rear surface 1b of the semiconductor substrate 1. The transparent conductive film 1c is provided for preventing the semiconductor devices from malfunctioning or being damaged owing to static electricity or the like charged on the finger 3. The transparent conductive film 1c is sometimes grounded to a terminal (not shown).

Moreover, a reference numeral 2 designates a LED radiating incident light 2a composed of a near infrared ray and/or an infrared ray.

For entering a fingerprint 3a into the imaging sensors, the LED 2 radiates a near infrared ray and/or an infrared ray toward the finger 3 placed on the transparent conductive film 1c closely, which is provided on the rear face 1b of the semiconductor substrate 1. The incident light 2a is scattered in the inside of the fingertip, and exits from the portion of the fingerprint 3a and the like. The scattered light 2b transmits the transparent conductive film 1c and the substrate 1 to enter the solid state imaging devices 1a, by which the photoelectric conversion of the scattered light 2b is performed. Thereby, an image of the fingerprint 3a can be obtained.

Incidentally, in FIG. 1, a letter t designates the total thickness of the semiconductor substrate 1 and the transparent conductive film 1c, and a letter p designates the arrangement pitch of the solid state imaging devices 1a. If the thickness t is within a range from 25 μm to 150 μm inclusive, sufficient performance can be obtained. In particular, if the thickness t is within a range from 25 μm to 50 μm, a sufficient contrast can more suitably be obtained. Incidentally, since a film having a thickness of 1 μm or less, such as the ITO film or the like, is ordinarily used as the transparent conductive film 1c, it may be considered that the thickness t is practically determined by the thickness of the semiconductor substrate 1.

Moreover, if the semiconductor substrate 1 is thinned to be 30 to 20 μm or less, the transmittances of visible rays heighten. Consequently, a cheap red light source could be put to practical use. Such a thin semiconductor substrate 1 can be produced by working as follows. That is, first the solid state imaging devices 1a and peripheral circuits (not shown) are produced on a silicon wafer having an ordinary thickness, i.e. about 0.5 to 0.8 mm, by a known semiconductor process. After that, the silicon wafer is worked by performing a grinding process with a grind stone, a wet etching process with fluorinated acid or the like, or a dry etching process with plasma or the like. These processes may be combined with each other as the need arises. The grinding process has the highest working efficiency, but minute cracks are produced in the semiconductor substrate 1 by the grinding process. Consequently, it is desirable to finish the working by the use of the dray etching process or the wet etching process at last.

Moreover, it is also preferable that the thickness t of the semiconductor substrate 1 is within a range from about a half to three times as large as the pixel pitch p of the solid state imaging devices 1a.

The point will be described using FIG. 2.

Next, the thickness t of the semiconductor substrate 1 will be described by reference to FIG. 2.

FIG. 2 is a typical sectional view showing an enlarged light beam path portion of FIG. 1.

The light 2a emitted from the LED 2 enters the finger 3 placed on the semiconductor substrate 1 closely, and scattered in the finger 3. After that, the scattered light 2b enters the semiconductor substrate 1 through the fingerprint 3a portion.

As described above, the semiconductor substrate 1 is made of single crystal silicon, and the semiconductor substrate 1 has a good light transmittance in a wavelength area from a near infrared ray to an infrared ray. Consequently, the scattered light 2b reaches the solid state imaging devices 1a.

At a part where the fingerprint 3a and the rear face 1b of the semiconductor substrate 1 adhere to each other, the scattered light 2b which has arrived at the part at an angle θ1 from the inside of the finger 3 enters the semiconductor substrate 1 at an angle θ2, which is determined by the refractive indices of both the finger 3 and the semiconductor substrate 1, and then the scattered light 2b arrives at the solid state imaging devices 1a.

On the other hand, at a part where the fingerprint 3a and the rear face 1b of the semiconductor substrate 1 do not adhere to each other, the scattered light 2b exits into the air having a refractive index of about 1 at an angle θ3 larger than an angle θ2. As a result, many parts of the scattered light 2b is reflected by the rear face 1b of the semiconductor substrate 1, and it becomes difficult for them to enter the semiconductor substrate 1.

Moreover, even if the angle θ3 is small, the scattered light 2b passes two interfaces having different refractive indices, the air and the semiconductor substrate 1. Consequently, the loss of the scattered light 2b until the scattered light 2b arrives at the solid state imaging devices 1a becomes larger.

As a result, an image of the fingerprint 3a is projected on the solid state imaging devices 1a.

In this case, when an angle θ, which is determined by the pitch p of adjoining solid state imaging devices 1a and the thickness t of the substrate 1, becomes smaller, the quantities of the light entering into the adjoining solid state imaging devices 1a become substantially equal to each other. Consequently, the sharpness of fingerprint images is lost.

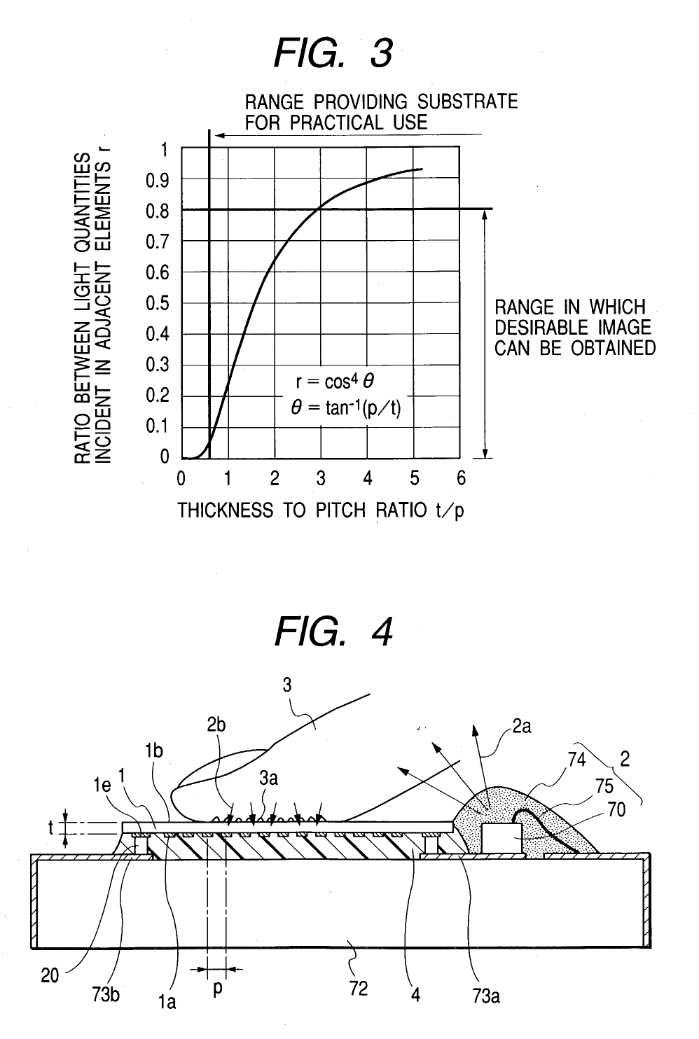

Incidentally, the situation will be described more minutely by means of FIG. 3.

FIG. 3 is a graph showing light quantity ratios to thickness to pitch ratios.

Supposing that a ratio of light quantities entering adjoining devices is designated by a letter r, and that an angle viewing the adjoining devices from a contact point of a fingerprint is designated by a letter θ, it is concluded that r=cos 4θ. That is, the light quantities entering adjoining devices are estimated to be almost proportional to cos 4θ(cosine fourth power law).

In this formulation, θ=tan−1(p/t) (the attenuation of the light quantity in the silicon substrate is neglected).

It is necessary for obtaining a good fingerprint image that the quantities of the light entering the adjoining devices are different from each other.

For obtaining a sharp fingerprint image, it is desirable that r≦0.8. FIG. 3 also shows that t/p is desirably 3 or less. Consequently, the angle θ is desirably about 20° or more, and the ratio of the thickness t to the pitch p is desirably equal to 3 or less. However, if the thickness t of the semiconductor substrate 1 is made to be 20 to 30 μm or less, the substrate 1 becomes too fragile to use practically. Therefore, the thickness t of the semiconductor substrate 1 is practically suitable to be within a range from a half to three times as large as the device pitch when the device pitch is made to be 50 μm or less.

(Second Embodiment)

FIG. 4 is a typical sectional view showing a fingerprint entering apparatus of a second embodiment of the present invention.

Incidentally, the components similar to those described above are designated by the same reference signs as those of the components described above.

In FIG. 4, a reference numeral 72 designates a wiring substrate; and a reference numeral 20 designates projection electrodes on the wiring substrate 72. The single crystal silicon made semiconductor substrate 1, on which semiconductor devices and the like are formed in the vicinity of its front face, is connected to the wiring substrate 72 through the projection electrodes 20 by the flip chip bonding. A reference numeral 73a designates the wiring on the wiring substrate 72.

The height of the projection electrodes 20 is about several micrometers to several tens micrometers. The projection electrodes 20 is provided on either or both of electrodes 1e on the semiconductor substrate 1 and electrodes 73b on the wiring substrate 72. As the formation method of the projection electrodes 20, known techniques such as metal plating, compression bonding of a metal made small-gage wire or metal balls, solder printing to be melted by heat, and the like can suitably be used.

Furthermore, as disclosed in the Japanese Patent Application Laid-Open No. 2001-81541, the projection electrodes 20 may be formed by performing the fluorination processing of a granular material of tin or a tin alloy before performing the compression bonding of the fluorinated granular material to the electrode 1e with heat.

The wiring substrate 72 is required to have rigidity endurable to the pressing force of the finger 3, and to have a thermal expansion coefficient approximate to that of the semiconductor substrate 1 of a silicon single crystal. Moreover, since the wiring substrate 72 is also necessary to endure the heating and the pressing of flip chip bonding, inorganic materials such as glass, ceramics and the like are advantageous.

Although organic materials represented by a glass epoxy substrate is desirable from the point of view of costs, the organic materials generally have a thermal expansion coefficient larger than that of the semiconductor substrate 1. Accordingly, it is necessary for the use of the organic materials to adopt a process of connection at a relatively low temperature in the flip chip bonding processes.

For the flip chip bonding, known techniques such as a technique using an anisotropic conductive resin, a technique using soldering, and the like can be used in consideration of the materials of the wiring substrate 72.

A LEDs 2 emitting light, especially an infrared ray and/or a near infrared ray, and the other electronic parts (not shown) can be mounted on the wiring substrate 72. But, since it is necessary to plane the semiconductor substrate 1 to be thin, which will be described later, the above-mentioned parts must be mounted at the last step in the process. The parts such as the LED chips 70, the wires 75 and the like are fixed with the sealing resin 74.

The thickness t of the semiconductor substrate 1 is required to be extremely thin such as about 150 μm or less, as described as to the first embodiment. Accordingly, an insulating resin 4 is filled between the semiconductor substrate 1 and the wiring substrate 3 for preventing the semiconductor substrate 1 from being bent to be damaged by being pressed down by the finger 3.

On the other hand, at the time of performing the mounting using the flip chip bonding, the thickness t of the semiconductor substrate 1 is preferably several hundreds micrometers or more. Accordingly, after the mounting using the flip chip bonding has been performed and the resin 4 has been filled, the rear face 1b of the semiconductor substrate 1 is ground to make the thickness of the substrate 1 be a predetermined thickness t.

Since the deflective strength of the silicon single crystal substrate is easy to lower owing to micro cracks caused by grinding working, it is preferable to perform mirror finish by chemical etching, plasma etching, polishing or the like after the performance of the grinding working.

Incidentally, similarly to the first embodiment, the thickness t of the semiconductor substrate 1 is suitably in a range from about a half to three times as large as the pitch p of the devices in the case where the pitch is made to be about 50 μm or less.

Next, the outline of a manufacturing process of a fingerprint entering apparatus of the present invention will be described.

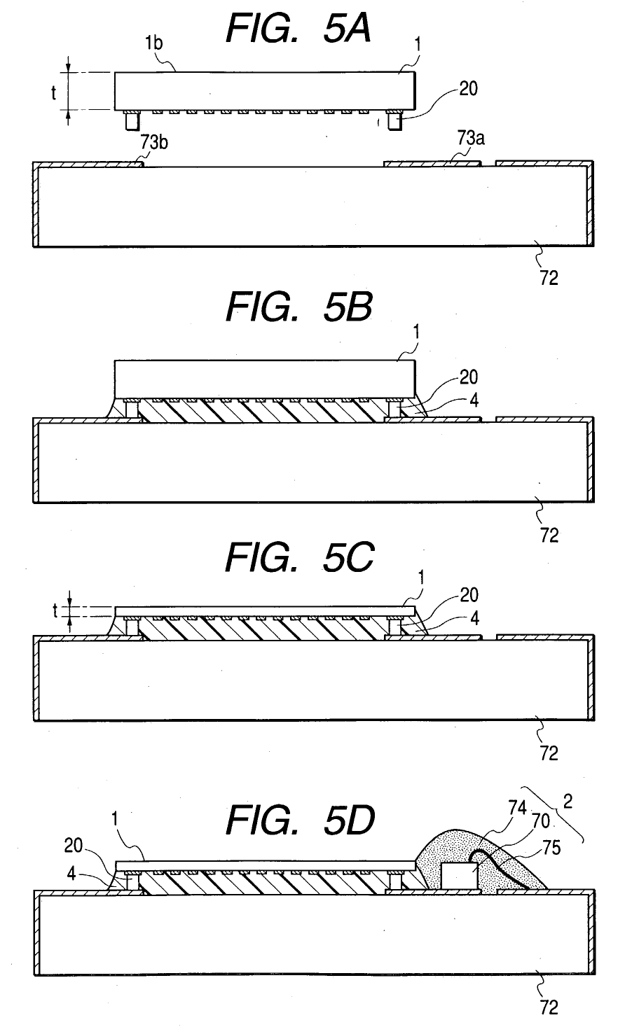

FIGS. 5A, 5B, 5C and 5D are typical sectional views showing a manufacturing process of a fingerprint entering apparatus of the present invention.

In FIG. 5A, the projection electrodes 20 are previously formed on the semiconductor substrate 1 by a known technology. The projection electrodes 20 are located to the electrodes 73b of the wiring substrate 72, and then the known flip chip bonding of the projection electrodes 20 are performed by heating and pressing the semiconductor substrate 1. In this case, the thickness t of the semiconductor substrate 1 is about 0.3 to 0.8 mm as long as no special reason exits. Moreover, the projection electrodes 20 may be formed on the electrodes 73b on the wiring substrate 72.

In FIG. 5B, the insulating resin 4 is injected between the semiconductor substrate 1 and the wiring substrate 72, and the injected resin 4 is cured. Since the thermosetting epoxy resin in which filler is filled up is generally suitable, heat curing is recommended.

In FIG. 5C, the thickness of the semiconductor substrate 1 is worked to a desired thickness t. As described above, the thickness t is required to be about 50 to 150 μm. First, grinding working is performed with a diamond grind stone, and then a dry process such as chemical etching using fluorinated acid, plasma etching and the like, mechanical grinding, chemical mechanical grinding, or the like is performed with the object of removing micro cracks (minute cracks of about several micrometers) produced by the grinding with the diamond grind stone. Thereby, the deflective strength of the semiconductor substrate 1 can be increased.

As the occasion demands, a transparent conductive film, an optical thin film filter and the like may be deposited on the rear face 1b of the semiconductor substrate 1.

In FIG. 5D, lastly, the other electronic parts such as the LED chips 70 and the like are mounted on the wiring substrate 72. In the figure, the form in which wiring is performed with wires 75 and the wires 75 are protected by the sealing resin 74 is exemplified. However, it is possible to adopt the other method in which, for example, the wiring is performed by soldering terminals of the parts packaged in advance.

In the following, a third embodiment to a fifth embodiment will be described. In these embodiments also, similarly to the second embodiment, the semiconductor substrate 1 and the wiring substrate 72 (a first semiconductor substrate 5 and a second semiconductor substrate 6 in the fifth embodiment) are connected by the flip chip bonding, and the spaces between them is filled up with the insulating resin 4.

(Third Embodiment)

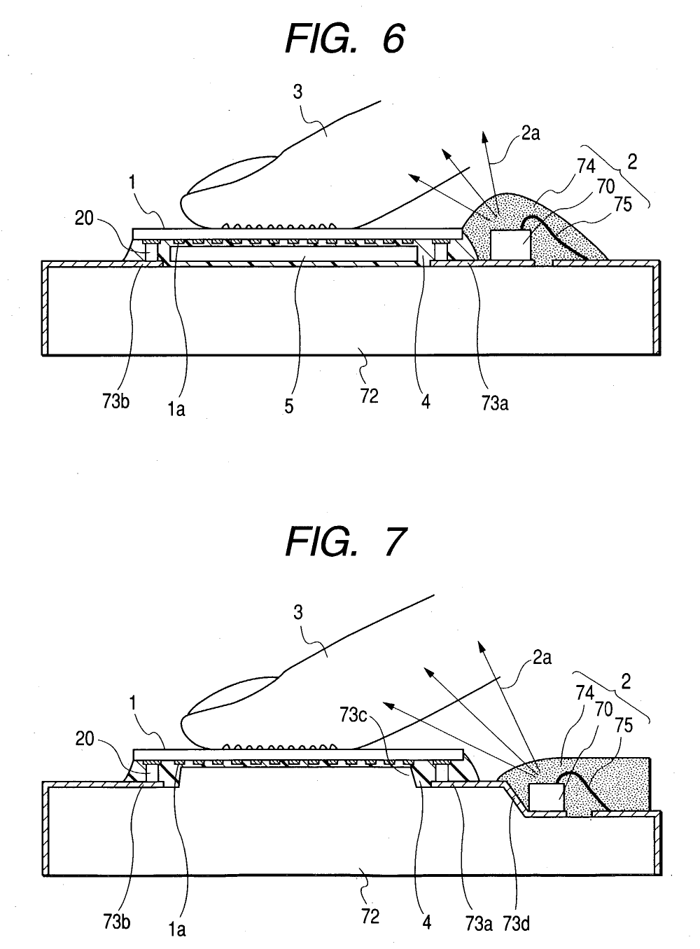

FIG. 6 is a typical sectional view showing a fingerprint entering apparatus of a third embodiment of the present invention.

Since an insulating film 5 is inserted between the semiconductor substrate 1 and the wiring substrate 72, the danger of the damage of the semiconductor substrate 1 owing to a press of the finger 3 can be more decreased.

The insulating film 5 is desirably one of the following: one formed by coating or sticking a photosensitive dry film, a photosensitive polyimide resin film or the like on either or both of the semiconductor substrate 1 and the wiring substrate 72 before executing predetermined exposure and development processes of the photosensitive films, and one formed by sticking an adhesive film of a polyimide resin, an epoxy resin and the like on either or both of the semiconductor substrate 1 and the wiring substrate 72.

Incidentally, in FIG. 6, the same components as those described above are designated by the same reference signs as those of the components described above.

Moreover, similarly to the first embodiment, the thickness of the semiconductor substrate 1 is suitably within a range from a half to three times as large as the device pitch in the case where the device pitch is made to be about 50 μm or less.

(Fourth Embodiment)

FIG. 7 is a typical sectional view of a fingerprint entering apparatus of a fourth embodiment of the present invention.

A step 73c is formed at a part of the wiring substrate 72 substantially corresponding to the range in which the solid state imaging devices 1a are formed. The size of the step 73c is equal to the height of the projection electrode 20 or smaller than that in some degree. The step 73c is not any obstacles to the connection by the projection electrode 20, and prevents the semiconductor substrate 1 form being bent and damaged by a press of the finger 3.

For forming such a step, it is advantageous to work the wiring substrate 72 by the Molded Interconnect Device (MID) technique.

As shown in FIG. 7, since the step portion 73d can simultaneously be formed, the whole apparatus can be arranged to be compact. Besides, it is also possible to mount the LED chip 70 and the like before the grinding work of the semiconductor substrate 1.

Incidentally, in FIG. 7, the same components as those described above are designated by the same reference signs as those of the components described above.

Moreover, similarly to the first embodiment, the thickness of the semiconductor substrate 1 is suitably within a range from a half to three times as large as the device pitch in the case where the device pitch is made to be about 50 μm or less.

(Fifth Embodiment)

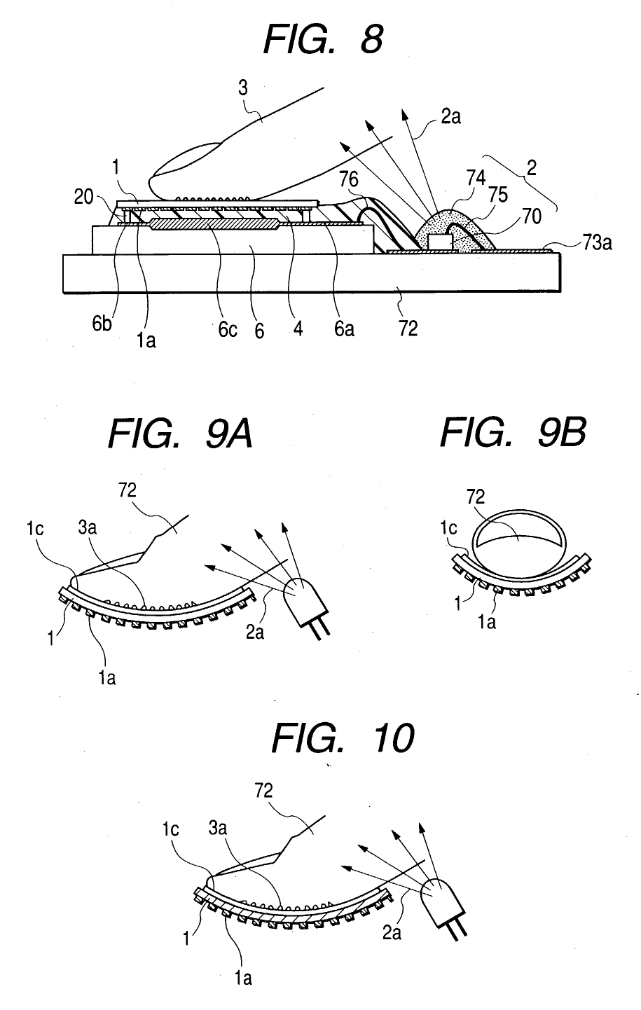

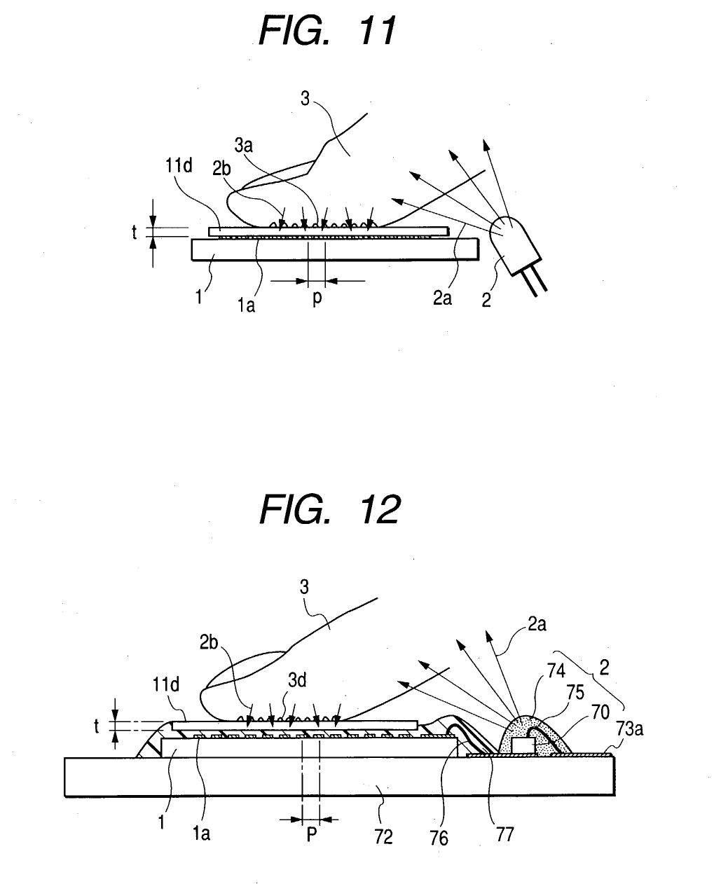

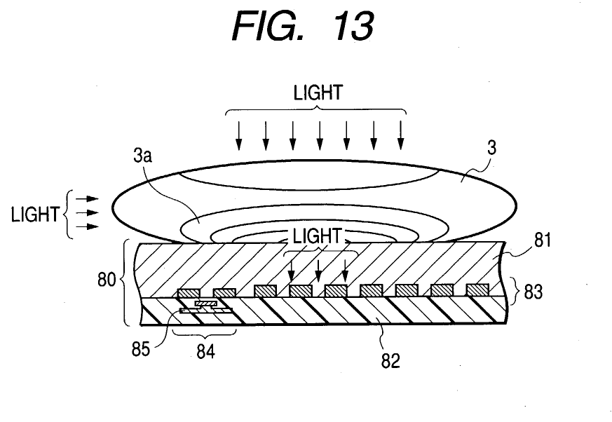

FIG. 8 is a typical sectional view of a fingerprint entering apparatus of a fifth embodiment of the present invention.

The semiconductor substrate on which the solid state imaging devices 1a are formed is supposed to be a first semiconductor substrate 1, and the semiconductor substrate on which a semiconductor device 6c having functions of signal processing and the like and an electrodes 6b are supposed to be a second semiconductor substrate 6. Both of the semiconductor substrates 1 and 6 are connected with each other through the medium of the projection electrodes 20. The wiring 73a on the wiring substrate 72 is connected with wiring 6a on the second semiconductor substrate 6 with the wires 76. Since both of the semiconductor substrates 1 and 6 are made of single crystal silicon and their thermal expansion coefficients are equal, there is no probability of generating any stresses and the like owing to the difference between the two thermal expansion coefficients even if the heating at the time of flip chip bonding is performed.

Moreover, an image signal of a fingerprint obtained by the solid state imaging devices 1a can receive processing such as predetermined image processing, fingerprint authentication and the like by the semiconductor device 6c.

By performing multi-chip mounting of such a silicon-on-silicon system, a fingerprint entering apparatus having higher functions can be configured.

Incidentally, the resin 4 is filled up in the figure, the insulating film 5 described above may be arranged in place of the resin 4.

Incidentally, the components similar to those described above are designated by the same reference signs as those of the components described above.

Moreover, similarly to the first embodiment, the thickness of the semiconductor substrate 1 is suitably in a range from about a half to three times as large as the pitch of the devices in the case where the pitch is made to be about 50 μm or less.

(Sixth Embodiment)

FIGS. 9A and 9B are typical sectional views of a fingerprint entering apparatus of a sixth embodiment of the present invention. The thin semiconductor substrate 1 obtained by the process described in connection with the above-mentioned second embodiment has flexibility and can be bent easily, though it is made of single crystal silicon being a brittle material. Accordingly, if the semiconductor substrate 1 is made to be bent at a curvature, namely with a radius of curvature of about several centimeters, with the rear surface 1b, which is the incident surface of the scattered light 2b, being on the inside of the bending, the rear face 1b can be contacted with the fingertip at wider area, and thereby the accurate shape of the fingerprint 3a can be entered.

Incidentally, the components similar to those described above are designated by the same reference signs as those of the components described above.

Moreover, the transparent conductive film 1c is ordinarily made of a film having a thickness of 1 μm or less such as an ITO and the like being a transparent conductive film.

Furthermore, similarly to the first embodiment, the thickness of the semiconductor substrate 1 is suitably in a range from about a half to three times as large as the pitch of the devices in the case where the pitch is made to be about 50 μm or less.

(Seventh Embodiment)

FIG. 10 is a typical sectional view of a fingerprint entering apparatus of a seventh embodiment of the present invention.

The semiconductor substrate 1 is a transparent insulating substrate made of glass, silicon, polyimide resin or the like, and the solid state imaging devices 1a are semiconductor devices made of an amorphous silicon thin film, a polycrystalline silicon thin film, or the like. These materials make it easy to form the semiconductor substrate 1 having a large area in comparison with that of the single silicon substrate. Thereby, a cheaper fingerprint entering apparatus can be obtained.

Moreover, the transparent conductive film 1c is ordinarily made of a film having a thickness of 1 μm or less such as an ITO and the like being a transparent conductive film.

Furthermore, by making the semiconductor substrate 1 as a colored filter which transmits the light having a frequency approximate to an infrared ray and absorbing visible light, unnecessary disturbance light can be removed.

Incidentally, all of the various shapes and structures shown in the embodiments described above are only examples for implementing the present invention, and therefore the scope of the present invention should not interpreted to be limited to the shapes and the structures. That is, the present invention can be implemented in various forms without departing from the spirit or the main features thereof.

Incidentally, the components similar to those described above are designated by the same reference signs as those of the components described above.

Furthermore, similarly to the first embodiment, the thickness of the semiconductor substrate 1 is suitably in a range from about a half to three times as large as the pitch of the devices in the case where the pitch is made to be about 50 μm or less.

As described above, the present invention can provide a fingerprint entering apparatus capable of being made to be thin, of being made of a small number of parts, of being made by a simple manufacturing process, and of being cheap.

What is claimed is:

1. A fingerprint entering apparatus comprising:
solid state imaging devices receiving scattered light from an inside of a fingertip, and
a substrate having a front face, on which a plurality of said solid state imaging devices formed, and a rear face, from which the scattered light enters the solid state imaging devices, said rear face being substantially parallel to the front face of the substrate,
wherein a thickness of said substrate is within a range from about a half to three times as large as a pixel pitch of said solid state imaging devices.

2. A fingerprint entering apparatus according to claim 1, wherein said substrate is a semiconductor substrate.

3. A fingerprint entering apparatus according to claim 1, wherein said semiconductor substrate bends with said rear face being an inside of bending, said rear face being an incident surface of said scattered light.

4. A fingerprint entering apparatus according to claim 1, wherein said semiconductor substrate is a single crystal silicon wafer.

5. A fingerprint entering apparatus according to claim 1, wherein said solid state imaging devices is composed of an amorphous silicon thin film or a polycrystalline silicon thin film.

6. A fingerprint entering apparatus according to claim 1, wherein an electroconductive thin film transmitting an infrared ray and/or a near infrared ray is formed on said rear face of said semiconductor substrate.

7. A fingerprint entering apparatus according to claim 1, wherein said semiconductor substrate includes a plurality of electrodes, a wiring substrate including a plurality of electrodes opposed to said electrodes is connected to said semiconductor electrode by flip chip bonding, and a gap between said semiconductor substrate and said wiring substrate is filled up with an insulating resin.

8. A fingerprint entering apparatus according to claim 7, wherein an insulating film is inserted into said gap between said semiconductor substrate and said wiring substrate.

9. A fingerprint entering apparatus according to claim 7, wherein a step is formed on a part of said wiring substrate substantially corresponding to a region of said semiconductor substrate where said solid state imaging devices are formed.

10. A fingerprint entering apparatus according to claim 7, wherein said wiring substrate is made of a material having a thermal expansion coefficient almost equal to that of said semiconductor substrate.

11. A fingerprint entering apparatus radiating light to a finger to receive scattered light from an inside of a fingertip with a solid state imaging devices, said apparatus comprising:
a first semiconductor substrate including a front face, on which a plurality of said solid state imaging devices and a plurality of electrodes; and
a second semiconductor substrate including a plurality of electrodes opposed to said electrodes on said semiconductor substrate, on a wiring substrate,
wherein said first and second semiconductor substrates are connected to each other with both of said electrodes by flip chip bonding;
a gap between said first and second semiconductor substrates are filled up with an insulating resin; and
said first semiconductor substrate has a rear face, to which scattered light from an inside of a fingertip enters, said rear face being almost parallel to said front face, a thickness of said first semiconductor substrate being within a range from about a half to three times as large as a pixel pitch of said solid state imaging devices.

12. A fingerprint entering apparatus according to claim 11, wherein an insulating film is inserted into said gap between said first and said second semiconductor substrates.

13. A method for manufacturing a fingerprint entering apparatus radiating light to a finger to receive scattered light from an inside of a fingertip with a solid state imaging devices, said method comprising the steps of:
providing a projection electrode on a semiconductor substrate including a front face, on which a plurality of said solid state imaging devices and a plurality of electrodes are formed, or on a wiring substrate including a plurality of electrode opposed to said electrode on said semiconductor;
connecting said semiconductor substrate to said wiring substrate by flip chip bonding;
filling up a gap between said semiconductor substrate and said wiring substrate with an insulating resin to cure the resin;
polishing said semiconductor substrate including a rear face, to which scattered light from an inside of a fingertip enters, said rear face being substantially parallel to said front face, before performing grinding work of said semiconductor substrate so that a thickness of said semiconductor substrate is within a range from a half to three times as large as a pixel pitch of said solid state imaging devices; and
mounting an electronic part on said wiring substrate.
